(19) United States
(12) Patent Application Publication
(10) Pub. No.: US 2022/0245821 A1
(43) Pub. Date: Aug. 4, 2022

(54) AUTOMATED LUNG CANCER DETECTION FROM PET-CT SCANS WITH HIERARCHICAL IMAGE REPRESENTATION

(71) Applicant: ElectrifAi, LLC, Jersey City, NJ (US)

(72) Inventor: Georgios Ouzounis, Weehawken, NJ (US)

(73) Assignee: ElectrifAi, LLC, Jersey City, NJ (US)

(21) Appl. No.: 17/162,435

(22) Filed: Jan. 29, 2021

(51) Int. Cl. G06T 7/11; G06T 7/62

(52) U.S. Cl. CPC G06T 7/11; G06T 7/62; G06T 2207/10081; G06T 2207/20084; G06T 2207/30061; G06T 2207/20081; G06T 2207/10104

(57) ABSTRACT

A system is proposed for automated detection and segmentation of lung cancer from registered pairs of thoracic Computerized Tomography (CT) and Positron Emission Tomography (PET) scans. The system segments the lungs from the CT data and uses this as a volumetric constraint that is applied on the PET data set. Cancer candidates are segmented from the PET data set from within the image regions identified as lungs. Weak signal candidates are rejected. Strong signal candidates are back projected into the CT set and reconstructed to correct for segmentation errors due to the poor resolution of the PET data. Reconstructed candidates are classified as cancer or not using a Convolutional Neural Network (CNN) algorithm. Those retained are 3D segments that are then attributed and reported. Attributes include size, shape, location, density, sparseness and proximity to any other pre-identified anatomical feature.

### FIELD OF THE DISCLOSURE

The present disclosure generally relates to medical imaging and signal processing in detecting target features in the body, and more particularly, to a system and method for processing data from CT and PET scans to detect and segment lung cancer.

### BRIEF DESCRIPTION OF THE DRAWINGS

FIG. 1 illustrates a registration or transformation of one image to another;

FIG. 2(A) broadly shows three platforms in the flow of medical information;

FIG. 2(B) is a flow chart presenting some steps of the disclosed system for diagnostics, processing and imaging;

FIG. 3 is a flow chart of an overview of the functions of subsystems SS1 through SS4;

FIG. 4 is a block diagram showing the process of subsystem SS1;

FIG. 5 is intentionally omitted.

FIG. 6(A) is an x-ray image from a CT scan of the lungs;

FIG. 6(B) is an inverted image of FIG. 6(A) after processing to show pixel groups;

FIG. 6(C) is a feature vector table that illustrates the resultant conversion of pixel groups from the image of FIG. 6(B);

FIG. 7 is intentionally omitted.

FIG. 8 is intentionally omitted.

FIG. 9(A) is a randomly selected axial view of the input data-set with the lung segmentation volume-set overlayed and displayed in color.

FIG. 9(B) is a randomly selected sagittal view of the input data-set with the lung segmentation volume-set overlayed and displayed in color.

FIG. 9(C) is a randomly selected coronal view of the input data-set with the lung segmentation volume-set overlayed and displayed in color.

FIG. 9(D) is a composite 3D rendering of the lung segmentation volume set superimposed over the 3D rendering of the registered PET scan

FIG. 10(A) shows a composite 3D rendering of the lungs, segmented from a CT scan, and a cancer segmented from the registered PET scan;

FIG. 10(B) shows a composite 3D rendering of the lungs, segmented from a CT scan, and a cancer, segmented from the registered PET scan, both superimposed over the 3D rendering of the entire PET scan;

FIG. 11 is intentionally omitted.

FIG. 12 is intentionally omitted.

FIG. 13 is intentionally omitted.

FIG. 14 is intentionally omitted.

FIG. 15 is intentionally omitted.

FIG. 16 is intentionally omitted.

FIG. 17 is intentionally omitted.

FIG. 18 is intentionally omitted.

FIG. 19 is intentionally omitted.

FIG. 20 is intentionally omitted.

FIG. 21 is intentionally omitted.

FIG. 22 is intentionally omitted.

FIG. 23 shows the operation of the SS2 subsystem;

FIG. 24 is a flow chart showing steps in the method of subsystem SS2;

FIG. 25 is a block diagram showing the apparatus of subsystem SS3;

FIG. 26 is a flow chart showing steps in the method of subsystem SS3; and

FIG. 27 is a block diagram illustrating the apparatus and method of subsystem SS4.

The figures depict various embodiments of the described device and are for purposes of illustration only. One skilled in the art will readily recognize from the following discussion that alternative embodiments of the methods and kits illustrated herein may be employed without departing from the principles of the methods and kits described herein.

### DETAILED DESCRIPTION OF THE DISCLOSURE

The disclosure describes a method and system for the detection of lung cancer or any other anomaly of a body organ that is visually distinguishable from other body areas in PET scans. It uses a stack of images from a CT scan and a stack of images from a PET scan of the same patient. The two stacks are registered. Registration is the alignment of data points in the two different scans so that they correspond spatially to the same anatomical point. The “targeted area”, (here being the lungs), is segmented out from the CT image stack. The segmented pair of lungs is overlaid with the registered PET data to identify the location of the lungs in the PET data.

Next, cancer candidates are identified within the location of the lungs in the PET data. Cancer candidates are identified using shape and intensity criteria and extracted in binary form using unsupervised pixel clustering methods with max-tree algorithm. The binary segments representing cancer candidates are then overlayed on the CT data to determine with greater clarity the appearance and textural properties of the selected regions. The latter are referred to as the cancer candidates on the CT domain. Once identified, they are refined using image processing techniques to exclude healthy tissue. The refined cancer candidates are then compared to a library of known lung cancer examples to determine which candidates are actually cancer. The output is a 3D volume set of the segmented lungs and a same size 3D volume set containing all verified cancer segments, or other anomalies specified as the “targeted condition. This method offers a very fast, low-cost and high-accuracy alternative in the diagnosis of a cancer or other anomaly, and allows for enhanced visibility of the detected anomaly (in this case cancer).

Although the detection of lung cancer will be referred to at times in describing the disclosure, it is to be understood that this is but one embodiment of the disclosure. The disclosed apparatus and methods can apply just as well to other parts of the body and for other anomalies, also which can be referred to as a “target feature,” a “targeted feature,” or a “target condition” or a “targeted condition” or an “anomaly”, in the body. For the purposes of the present disclosure, an anomaly or the phrase “target feature” or “target condition” refers to what is sought to be detected, such as cancer as in a cancerous tissue.

The disclosed apparatus and methods can, more broadly, apply to detect anatomical features and conditions within organs that show up in PET scans. Such organs may be the lungs, heart, liver, and or stomach or any other body part. The target feature may be an organ in the body of an animal, a mammal or of any creature not necessarily of the human species.

CT and PET scanning machines are just two examples of the many different scanning options available to convert a medical scan of a body into data that defines a target or targeted area.

For the purpose of this disclosure, the following words or phrases listed here are to have, or be understood as having, the following meanings or definitions as used in the context of the medical imaging described.

The targeted anomaly or condition can be referred to as a “target feature,” a “targeted feature,” o a “target condition,” “targeted condition” or a “target” or “anomaly”, in a body organ. For the purposes of the present disclosure, an anomaly or the phrase “target feature” or “target condition” refers to that which is sought to be detected, such as cancer as in a cancerous tissue or cancerous tumor in an organ. A target feature is defined for the purpose of this discussion as a data set representation of an area of focus by a medical professional. The target area is a body organ or organs, such as the lungs, the heart, liver, and the anomalies can refer to tumors and the “ground-glass” patterns associated with pneumonia, apparent to skilled medical professionals.

The body organ within which the target feature is searched comprises a certain area or structure defined by a boundary, as apparent to skilled medical professionals. For purposes of this disclosure, this area may be referred to as the “target structure” or “target area” within which the search for the “target feature” or “target condition” or anomaly is conducted.

The terms “supervised” learning and “unsupervised” learning are also used. In the former term, data come with labels; thus a relationship can be established (learned). In the latter term, patterns are searched based on which assumptions can be drawn.

The word “segmentation,” or the phrase “segmenting an image,” refers to locating objects and boundaries (boundary lines, boundary curves, etc.) in images. In the context of medical imaging, image segmentation is the process of dividing a visual input (an image) into segments to simplify image analysis. The segments represent objects or parts of objects, and comprise sets of pixels, or “super-pixels”. Segmentation can be used to assign a label to every pixel in an image such that pixels with the same label share certain characteristics.

The word “thresholding,” or thresholding in imaging, is a type of image segmentation where the intensity of pixels is modified to either of two states, background or foreground, to make the image easier to analyze. In thresholding, an image is converted from color or grayscale into a binary image, i.e., one that is simply black and/or white. Conventionally white color is assigned to foreground features or features of interest, and black to all other pixels.

The term “deep learning” refers to a machine learning method that utilizes neural network architectures to perform imaging tasks. The technique is especially useful when large amounts of data are involved as in medical imaging, and includes using segmentation, object detection (identifying a region of interest) and classification. It can capture hidden representations and perform feature extraction most efficiently. In deep learning, computers learn representations and features automatically, directly from algorithms working on the raw data, such that the data does not require manual preprocessing.

The term “CT domain” as used herein means that the data or one or more images are formed, collected or produced from the information generated by a CT scanning machine or equipment. In contrast, the term “PET domain” means that the data or one or more images are formed, collected or produced from the information generated by a PET scanning machine or equipment.

The disclosed methods and system apparatus are used with CT and PET scanning machines to convert a medical scan of a body into data that defines a target or targeted area. The disclosure's signal processing of data for detection of a target feature involves medical imaging and body scanning techniques including, CT scanning, PET scanning, and the combination of CT-PET data processing. Each of these approaches are adept at detecting anomalies in targeted structures, which can, in some instances, avoid the need for exploratory surgery.

CT Versus PET Imaging

Differences in CT imaging capabilities, also sometimes called a CAT scan (computerized axial tomography), and PET imaging capabilities (positron emission tomography) have resulted in realizing and perfecting a novel way for detecting anomalies in the body using the combination of medical scanning and effective data processing and image reconstruction. This has been achieved by superimposing selected features from PET scan data onto CT scan data using advantages available with each technology but combining them in a unique way through data processing and system sequences to produce an output CT image that shows more clearly the targeted condition within the targeted structure.

The techniques disclosed use CT imagery both as an input and as the output. PET imagery is used to gain benefits and solve long felt problems of cost and time associated with detecting target conditions in target areas of the body. The registration of CT and PET scan data points allows for efficient processing in the PET domain while maintaining benefits of the CT domain according to the apparatus and methods that have been discovered for achieving the solutions to this long felt need in this medical field.

Since a CT scan is essentially a surface rendition of an anatomy by means of body scanning machine, the method makes use of its feature as an imaging tool to produce images of the inside of the body, or in other words, to take pictures of internal organs. The method applies certain CT capabilities which, although limited, are still significant, such as the CT's showing of bone structure, soft tissue and blood vessels, and uses the CT's capabilities to determine the exact size and location of tumors with reference to bone structures.

The CT scanner by default captures consecutive 2D slice starting from a certain start point of the body to an end point of the body. These images are stacked together into a volume set that can be rendered in 3D. The rendering may be computationally intensive but that is all. The formation of the volume sets is trivial. The data size of volume set naturally introduces challenges regarding the efficiency of processing algorithms. This becomes particularly important in supervised processes, but since the present method is unsupervised, there is no requirement for a vast collection of volume sets at the input for training purposes.

The method disclosed is realized by uniquely applying PET scan data with CT data. PET scans have limited resolution which do not allow for the sharp extraction of features but do highlight particular conditions or organs in a unique way. This property is used as a guide in the segmentation of CT data.

In an embodiment for detecting lung cancer, the lungs are first detected from 2D slices of the CT data and are extracted in 3D using the apparatus and method of subsystem SS1. Cancer candidates are found within the spatially constrained PET data set using the 3D lung segmentation.

The present method uses a minimal model method that is trained on only a few hundreds of annotated 2D images of lung cross-sections. As a result, the disclosure/system described is very fast and can operate on regular hardware, i.e. laptops. Dedicated devices such as custom GPU servers or other expensive infrastructures are not required.

Registration

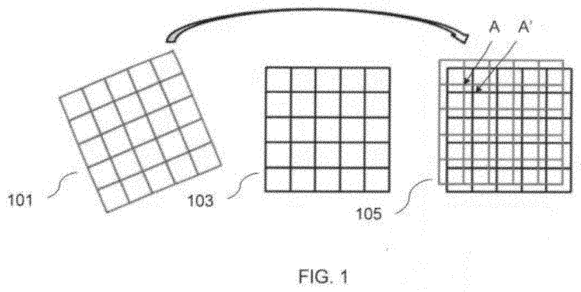

FIG. 1 shows a registration or transformation of one image to another. The method begins with the input of two data-sets, namely derived from CT and the PET scans. The two data-sets need to be registered, i.e. to coincide spatially and be of the same dimensions in all three axes (image planes) and number of planes. The basic concept of registration is to overlap one scan with another and align data points, transforming one image over a fixed image. It is the determination of a one-to-one mapping between the coordinates in one space and those in another, such that points in the two spaces that correspond to the same anatomical point are mapped to each other.

Registration applied to two scans conducted of a body in the medical field means that one data set remains as is while the second one is transformed using some algorithm into a new data set. One data set, or stack of images of a body, is moved over another data set such that points (or nodes) in one image are aligned to corresponding points in the other data set. The two data sets need to be the raw captures. If the user provides a segmentation and another raw dataset, the registration algorithm may have difficulties identifying the common features for it to do the transformation.

In FIG. 1, in a simple illustration of registration by spatial transformations, image 101 is transformed 103 and the result is the two overlapping images 105. Points that coincide on both images are noted, one example being points A and A′ in FIG. 1. If the boundary of an organ is clearly visible on moving image 101, that could be used to identify the boundary of the corresponding image that is not so clear or even discernible on fixed image 103. In other words, if a clearer image in moving image 101 is placed over a more obscure image in fixed image 103, the contours or boundary line of the image 101 can be confirmed on image 103 by noting the points of the two images that align up with one another. The points or nodes could be data points generated by a scan of a body.

In one embodiment, moving image 101 is a full or partial body scan of a human body performed by a CT scanning equipment. Fixed image 103 is also that of a full or partial body scan of a human body, this one performed by a PET scanning equipment. Image 101 of the CT scan produces a clearer and better defined image of body parts in this example as compared to the image 103 of the PET. By registration of the two images, points clearly detectable in one of the two scans can be used to identify the same points in the other scan. These common data points may later become identified as target “candidates”. If the target is, for example, cancer in the lungs, common data points are transformed on the PET scan as “cancer candidates.” The word “candidate” is used to mean that the initial common points may be, or may not be, actual cancers. That determination is made in a later data processing of each found node transformed into the CT image of the target area from the PET image after registration of the CT data and PET data.

Algorithms Used in the Data Processing

The disclosed system and methods use two principal algorithms.

(A) The Max-Tree Algorithm

A max-tree algorithm is used in carrying out the data processing of large amounts of data generated from body scanning equipment. The max-tree is a hierarchical image representation structure from the field of mathematical morphology. The data-structure represents an image through the hierarchical relationship of its intrinsically computed connected components. This is a computationally efficient alternative to the brute-force approach in which for each possible intensity threshold a binary image is generated and each binary connected component is labeled. The max-tree is uniquely applied and constructed in the present disclosure so to achieve a more accurate segmentation of a target feature in the absence of training data and in a shorter time and with less cost by using off-the-shelf computers without the need for expensive custom types of processing equipment.

The hierarchical image/volume representation data structure that the max-tree algorithm provides enables the organizing and indexing of the image information content for rapid responses to image queries. The max-tree algorithm orders the set of connected components of the input data set based on intensity. Connected components are groupings of foreground pixels/voxels that are pair-wise adjacent in each threshold set of the input data. A threshold set is an image or volume separated in a foreground and background regions based on an intensity threshold.

Each node of the tree corresponds to a single connected component of the data and each unique connected component (excluding fully overlapping ones) is mapped to a single node of the tree. Each node points to its parent node which represents a coarser connected component at a lower intensity value. The root node corresponds to the background, i.e. the set of pixels/voxels of the lowest intensity, points to itself. The leaf nodes of the max-tree data structure correspond to connected components that have no other adjacent connected component at the same or higher intensity. The max-tree of the inverted (intensity-wise) image or volume set is referred to as the min-tree representation.

(B) The Minimal Model Algorithm

A minimal model algorithm is used in applying the minimal model method (MMM) that uses a collection of binary 2D images. In one embodiment, the color white is for foreground information (objects detected), and black is for everything else. In another embodiment, there may be alternative colors based on updated software. Only two colors are used, be they black and white or whatever other two colors are chosen to be used.

The minimal model method develops a statistical representation of a shape of a 2D/3D object using a collection of connected component attributes. The latter are numerical representations of shape properties of connected components. The minimal model method in this embodiment uses binary 2D target features or binary 2D cross sections of a 3D target feature imaged in any domain, which in this case is a CT scan. The cross-sections are selected to show appearances that are the most distinctive of the targeted 3D object and that allow for easy discrimination from other image features/objects. For each object in the training set, the method computes a unique shape descriptor that is in the form of a vector of attributes (in one embodiment, 10 floating point numbers). Upon feature extraction and preprocessing, MMM constructs a feature space in which entries are clustered together with the aim of computing the cluster's mean and variance and detecting and discarding outliers.

In one embodiment, in the deployment phase using the developed feature space, the algorithm computes the max-tree (or min-tree) representation of each consecutive plane of a new 3D data set and attributes each max-tree node with the same shape descriptors as in the training phase. It then runs a pass through the data structure. For each node visited, its vector of attributes is projected in the feature space. The point on the feature space that the feature vector corresponds to is referred to as its signature. If its signature is found to be in close proximity (below a pre-determined threshold) to the center of the cluster, this proximity measure is registered along with the plane index and the node identifier, pointing to the corresponding connected component.

For each successful signature detection, a subroutine updates the best matching connected component thus far. At the end of this phase and after processing all image planes in the 3D data set, the MMM registry holds the one connected component that was found (if any) to be of the closest proximity to the mean of the feature space cluster and below the proximity threshold. MMM then computes the max-tree (or min-tree) of the entire volume set, i.e. in 3D, and identifies the node that accounts for the 3D connected component that has a cross section that best matches the connected component stored in the MMM registry; i.e. its closest superset. That 3D connected component is then extracted from the tree and stored as the desired output segmentation.

Identifying a Target Condition

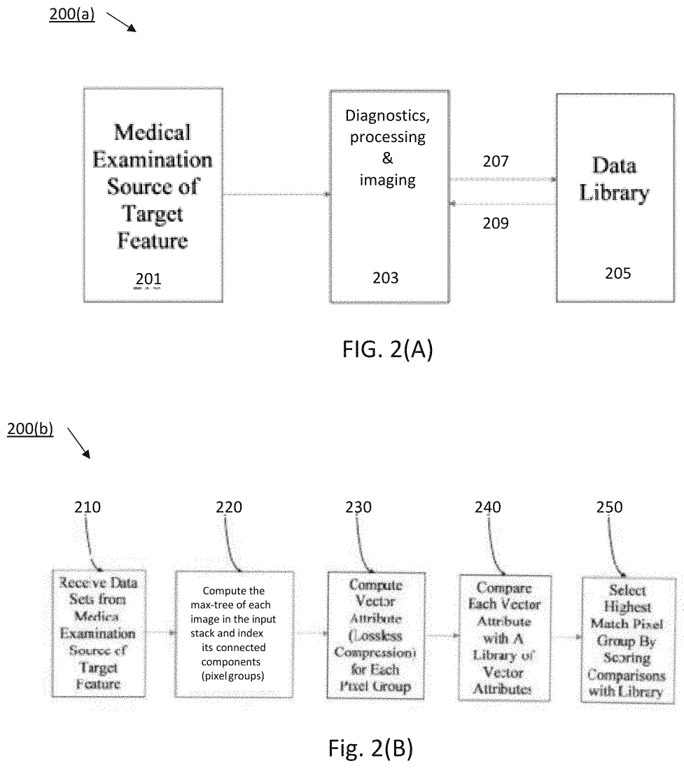

FIG. 2(A) broadly shows three platforms for the flow of medical information. A medical examination is conducted that results in the generation of patient data. This can be conducted a number of ways, but relevant to this disclosure is that a CT or PET scan is taken of the patient's body. Details of the generation of the data, that is, module 510 in FIG. 2(a) is outside the scope of this disclosure except that the system of the disclosure receives as its starting point data generated from a CT scan and a PET scan of a source, such as a patient's body and/or a targeted body organ. The disclosure at 520 applies the disclosed system's diagnostics, processing and imaging techniques to the inputted data to identify a target condition, such as cancer, in a target area of the body, such as the lungs. In the course of the disclosed system and methods, in one embodiment a data library 530 is bi-directionally accessed 207, 209 for use in identifying the targeted condition.

FIG. 2(B) is a flow chart presenting some steps of the disclosed system for diagnostics, processing and imaging. This shows a method 200(b) and structure with some of the disclosed steps for examining one or more target features. FIG. 2(b) presents the information still at an overview level, and for reference, this expands to some extent on the diagnostics, processing and imaging function block at 203 of FIG. 2(a).

At step 210 the system receives from a medical examination source at least one data set associated with the target feature or condition. A data set can be reduced to a series of numerical representations. Once reduced into the data domain, the target feature is then enhanced for closer examination, study and detection. The at least one data set created for the target feature is rescaled to enable for processing benefits, such as for enhanced speed without the need for a specialized computer to perform comparison and matching identification.

At 220, each two dimensional image belonging to the data set received from step 210 is processed to identify its constituent connected components using the max-tree algorithm. As an example, where the medical examination equipment s a CT scanner, the data sets from a CT scan received in step 220 will correspond with a series of two-dimensional cross-sectional views of the target feature. Each of these two-dimensional cross-sectional views is reduced to a data set of floating numbers. This data set of floating numbers comprises at least one group of pixels or pixel groupings. Each two-dimensional cross-sectional view will likely house many pixel groups, one or more of which will contain the target feature.

With the pixel groups created for each two-dimensional (2D) cross-sectional view, the system at step 230 computes a vector attribute for each pixel group. This approach takes into account considerations such as gray-scale. The vector attribute representation of each pixel group is a lossless compression of its shape information.

With vector attributes calculated for each pixel group making up a data set from the source, the system at step 240 compares each vector attribute to a library of vector attributes. This is to determine whether one or more pixel group, now characterized as vector attributes, can be authenticated, and to what extent, using known data from an outside source, such as a data or image library. Pixel groups not authenticated are ignored. While the library can be formatted in any number of ways, in one embodiment, the library format is an uncompressed structure or as a lossy or lossless compression structure. In another or same embodiment, the library comprises vector attributes. Methodologically and systematically, the selection of the most prominent vector attribute of the data set and in relation to the data library can be performed within the medical examination source performing the method 200(b).

The purpose of comparison step 240 is to compare each pixel group with the library of data to determine if there is, or are, known similarities between the target feature from the medical examination source and the pool of existing data.

After performing the comparison, the system at step 250 selects the highest match pixel group from scores resulting from the comparisons with the data, image or vector attributes' library. In one embodiment, this selection is executed using machine learning. In selecting the highest match or matches, step 250 scores or grades each match of each vector attribute against the target feature and the data library. A score threshold can be utilized. This eliminates any match, including the highest match or matches, that fail to meet or exceed a threshold score.

Subsystems SS1-SS4

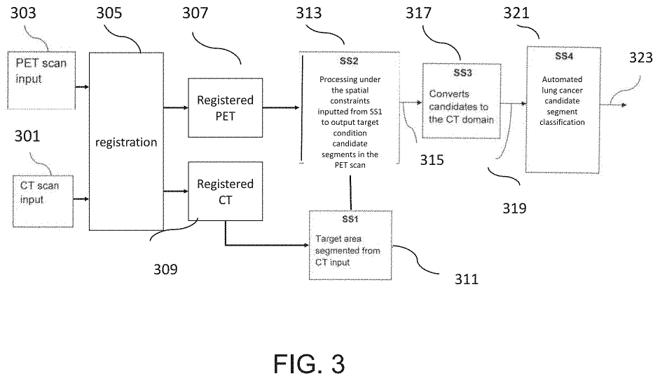

The novel system and method of this disclosure is made up of four subsystems, identified as SS1, SS2, SS3 and SS4. FIG. 3 is a flow chart that gives a broad sketch of the relationship of the four subsystems. In FIG. 3, each subsystem block is labeled, SS1-SS4. The source data and inputs to the system of the disclosure are also included to show that two registered data sources are received across SS1 and SS2, and the data source details are outside the scope of this disclosure but are presented as a point of reference only.

In first considering an overview of the four subsystems and with reference to FIG. 2, there are two inputs. One data source is from a CT scan of a patient 301. The CT data consists of a stack of CT images from the scan of a torso as the source of the data. The word “torso” is used here to mean a partial or full body scan that contains at least the part from the pelvis to the neck. Another data source is from a PET scan of the patient 303. Both the PET scan 303 and the CT scan 301 are fed to a registration module where at least one and depending on the registration method maybe two different data sets are registered. Registration 305 outputs registered PET data 307 which is inputted to SS2 at 313. Also Registration 305 also outputs registered CT data 309 which is fed into SS1 at 311. Thus the PET and CT data sources 201, 203, are registered a-priori and before SS1. Thus received at the disclosed system is registered CT data as the input to SS1 and registered PET data as the input to SS2.

SS1 at 311 contains an automated segmenter using the MMM that segments out the target area from the CT body scan. It extracts the target area with high precision and in an unsupervised manner. The output of SS1 is a segmented target area in the format of a binary volume set. Foreground pixels (white) coincide with the lung tissue in the original, and the background pixels (black) with everything else.

SS2 at 213 detects candidates for a targeted condition and the candidate area(s) on the PET data volume set are segmented. SS2 receives the inputs of the registered PET data from 307, and the target area in the form of binary-formatted volume set from 311.

SS2 computes a hierarchical representation (max-tree data structure) of the input PET volume set. It detects a targeted condition, e.g. cancer, and registers relevant findings as “candidates” from coinciding points on the binary CT lung segmentation and PET volume sets. SS2 213 segments the points on the PET data constrained by the CT's segmented lung volume set (from SS1 at 211) as the driver using the max-tree representation of the PET dataset. It identifies all tree branches that correspond to image regions (“candidates”) that stand out from their immediate neighbors by means of signal intensity. Cancer candidates show up with a high signal value in the PET scans. SS2 at 213 outputs at 215 a set of spatially well-defined cancer candidate segments detected in the PET scan.

SS3 at 317 receives as input the candidate segments from SS2. SS3 217 converts the identification of cancer candidates from the PET to the CT domain. All possible cancer candidates are segmented into the CT scan. SS3 outputs at 219 a highly accurate cancer candidate segmentation from the CT domain

SS4 at 321 conducts an automated classification of candidates of the targeted condition extracted from the CT scan. SS4 classifies whether each 3D segment corresponds to the targeted condition or some other condition using the successive cross sections of each segment along with a neural network binary classifier. The SS4 classifier uses the minimum enclosing box around each cancer candidate segment from the CT scan to access the relevant planes of the 3D CT dataset and extract the sequence of image patches defined by the bounding box. Each 2D patch is inputted to a pre-trained classifier. For example, if the target condition is cancer, the classifier is pre-trained on lung cancer 2D image patches from CT datasets. If the classifier detects a patch as a cancer image, the 3D cancer candidate segment is retained and relabeled as a detected 3D cancer. This is repeated for each 3D cancer candidate segment.

SS4 at 321 quantifies each retained cancer segment by computing attributes such as size, shape, location, spatial extent, density, compactness, intensity, location and proximity to any other reference anatomical features provided externally. SS4 outputs at 323 an image (a volume set) of the lungs in the CT domain that shows attributed cancer segments.

Details of SS1

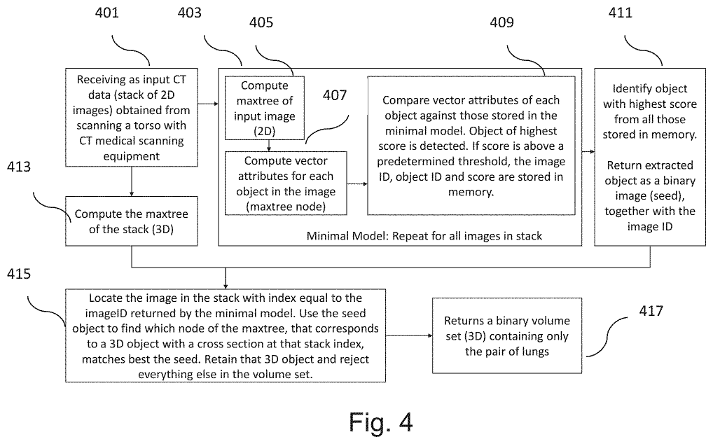

FIG. 4 is a block diagram showing the apparatus and process of subsystem SS1. At Receiver 401, SS1 receives CT data input that consists of a stack of 2D images. This is obtained from the scanning of a torso with CT medical scanning equipment. Receiver 401 supplies an output to a Minimal Model 403, also known as a minimal model method (MMM) or MM algorithm, where a MMM processing is performed and repeated for all images in the stack.

Modules within the MMM are image max-tree 405, vector generator 407 and comparator 409. Image max-tree 405 computes the max-tree of the 2D input image and outputs its result to vector generator 407. Vector generator 407 computes vector attributes for each object in the image (max-tree node), and outputs its result to comparator 409. Comparator 409 compares the vector attributes of each object against those stored in the minimal model library. The object with the highest similarity score against the MMM feature space representation of its library is detected. If the score is above a predetermined threshold, the image ID, object ID and score are stored in memory.

Output of minimal Model 403 is sent to Identifier 411 where the object with the highest score from all those stored in memory is identified. The output of Identifier 411 is to return the extracted object identified as a binary image (seed), together with the image ID.

Returning attention to Receiver 401, A second output delivers the CT data in the form of a stack of 2D images to stack max-tree 413. Stack max-tree 413 computes the max-tree of the stack (in 3D).

Outputs of Identifier 411 and stack max-tree 413 are together inputted to Locator 415. At Locator 415, the image in the stack with an index equal to the image ID returned by the minimal model is located. The seed object is used to find which node of the 3D max-tree, that corresponds to a 3D object with a cross section at that stack index, matches best the seed. That 3D object is retained and everything else in the volume set is rejected.

Output of the image located at Locator 415 is inputted to Volume set output 417 module which returns, or outputs, a binary volume set in 3D containing only the pair of lungs.

If an external segmentation of the lungs is provided along with the two input data sets (PET and CT), SS1 becomes redundant otherwise, segmentation of the targeted area/lungs is computed with SS1 using the minimal model method on the inverted (intensity-wise) CT data set along with the max-tree algorithm.

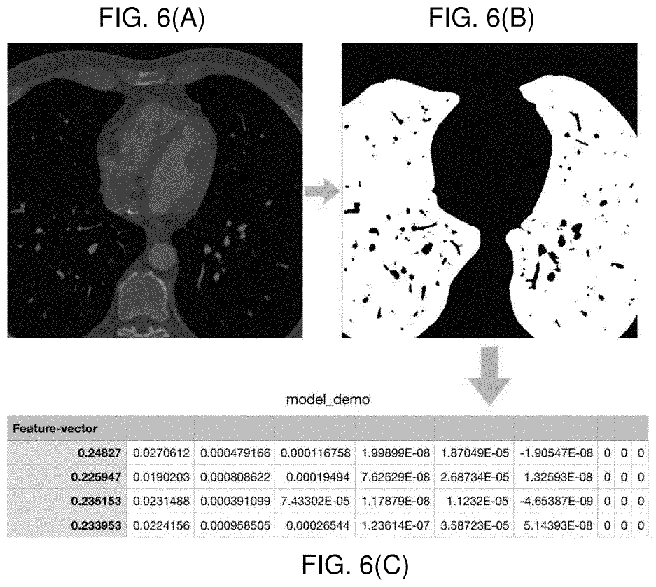

FIG. 6(A) is an cross-section image from a CT scan of the lungs. FIG. 6(B) is the result of the MMM applied on FIG. 6(A) and aiming for the lungs; and FIG. 6(C) is a feature vector table that illustrates the resultant conversion of pixel groups from the image of FIG. 6(B).

FIG. 6(B) is generated after detecting the one connected component of the max-tree representation of FIG. 6(A) that has the highest similarity score with the centroid of the feature space cluster of the minimal model, pre-trained with images of the lungs. The result in FIG. 6(B) is a clearer view of the targeted area of interest. The feature vector table that is created lists vector attributes of detected pixel groups, documenting attributes such as size, location, intensity. This is known as “staging data” for candidates identified by the pixel groups.

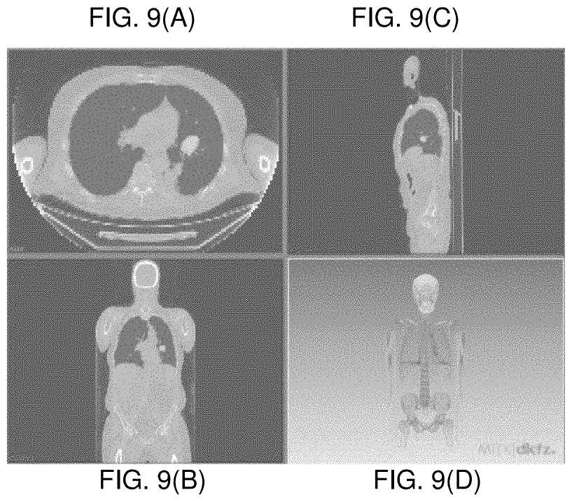

FIG. 9(A) to (C) show the axial, sagittal and coronal views of the original data set with the lung segmentation highlighted using the green color. FIG. 9(D) shows the 3D rendering of the segmented lungs superimposed on the PET data as it is intended to be used in SS2.

SS2—Cancer Candidates' Detection and Segmentation from PET Scans Using the Lung Segmentation (SS1) as a Driver.

The SS2 subsystem computes a hierarchical representation (tree data structure) of the input PET volume set. It identifies all tree branches that correspond to image regions that stand out from their immediate neighbors by means of signal intensity. All such regions, referred to as “candidates,” are subjected into a test that evaluates which of them or their constituent sub-regions are “mostly” within the segmented lungs. Those accepted coincide with cancers or other lung conditions as there are no other anatomical features within healthy lungs that show up with a high signal value in PET scans.

Candidates that pass this test but are of weak signal intensity are discarded. The criterion is computed automatically using machine learning techniques from local regions that are always represented by a strong signal. An example is the heart that stands out from all its adjacent neighboring regions and itself is adjacent to the lungs, All verified candidates are then reconstructed. In this step, any group of adjacent or almost adjacent candidate sub-regions are clustered into a single object that accounts for the cancer candidate after correcting for segmentation artifacts.

SS2 computes the max-tree representation of the PET dataset, i.e. it is a max-tree of a 3D dataset. Once the data structure is computed, each node is attributed with the size metric, i.e. the number of voxels that make up the corresponding connected component.

FIG. 23 shows the operation of the SS2 subsystem. At its starting point, registered PET data 2301, in the form of a 3D image stack that represents a volumetric PET data set, is inputted to Constructor 2303 where the max-tree of the PET stack is computed. The input of registered PET data favorably constrains the search space to the region of the targeted body organ, in this example, the lungs. Output of Constructor 2303 is sent to Filter 2305 where objects are rejected, filtered out, based on spatial and intensity criteria. Also, a driver input to Filter 2305 is a CT lung segmentation 2307 in the form of a registered image stack. The two source datasets, the PET and the CT, are pre-registered at the very beginning, before SS1. The max-tree algorithm is not involved in that registration process.

The filtered output from Filter 2305 is delivered to extractor 2309 that reconstructs and extracts the targeted condition candidates, here cancer candidates. The extracted candidates are then sent as an input to Imager 2311 that outputs a binary volume set of cancer candidates extracted from the PET dataset. The minimal model is not involved here at all as it was exclusively in SS1.

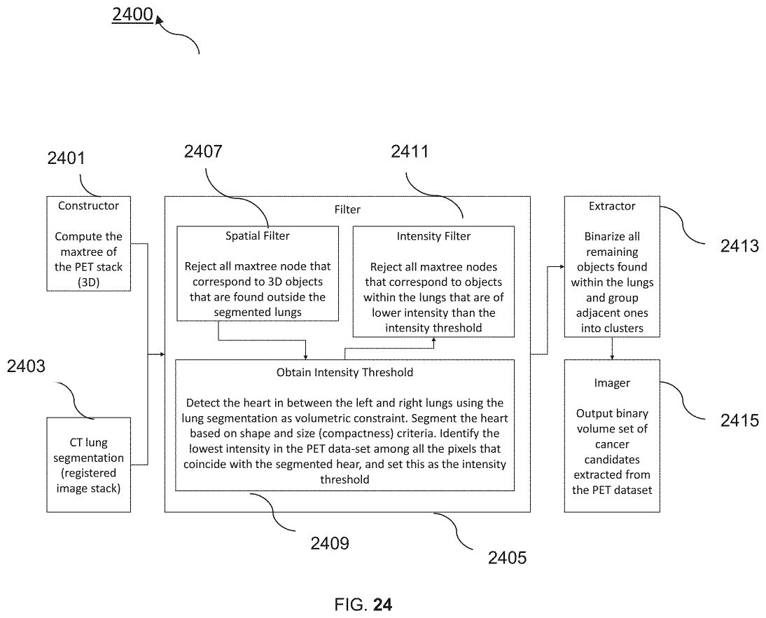

FIG. 24 is a flow chart showing steps in the method of subsystem SS2. Constructor 2401 computes the max-tree of the PET stack (3D). CT Lung Segmenter 2403 segments the lung from the CT body scan. Outputs of Constructor 2401 and CT Lung Segmenter 2403 are fed as two inputs to Filter 2405 which contains sub-modules Spatial Filter 2407, Intensity Thresholder 2409 and Intensity Filter 2411. The two data inputs are received at Spatial Filter 2407 where the filter rejects all max-tree nodes that correspond to 3D objects that are found outside of the segmented lungs. The outputted filtered data is fed to Intensity Thresholder 2409. The Intensity Thresholder detects the heart in-between the left and right lungs using the lung segmentation as a volumetric constraint. The heart is segmented based on shape and size (compactness) criteria. The lowest intensity in the PET data-set is identified among all the pixels that coincide with the segmented heart, and this is set as the intensity threshold.

Intensity Thresholder 2409 delivers its output to Intensity Filter 2411 that rejects (filters out) all max-tree nodes that correspond to objects within the lungs that are of a lower intensity than the intensity threshold.

Extractor 2413 receives the thus-filtered data and binarizes all remaining objects found within the lungs and groups adjacent ones into clusters. The extracted objects and clusters are fed to Imager 2415 where it uses the processed data from the preceding subsystems to output a binary volume set of cancer candidates extracted from the original PET dataset.

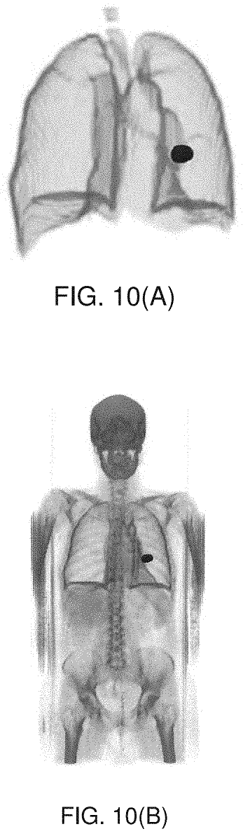

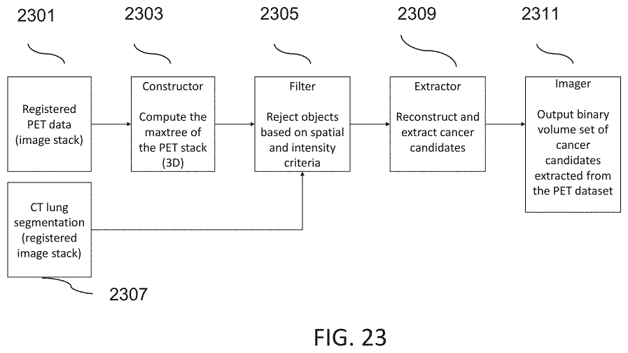

FIG. 10(a) shows the segmentation of lungs from a CT scan with a cancer detection extracted from SS2, in 3D. FIG. 10(b) shows the same result overlayed on the input PET volume set for reference to other anatomical features.

SS3.—Cancer Candidate Segmentation from CT Scans.

The result from subsystem SS2 is a set of one or more segments that coincide with cancer candidates in the PET scan if any are detected. As PET scans are of low resolution, accurate segmentation of cancers or other conditions requires CT scans that offer better visual clarity.

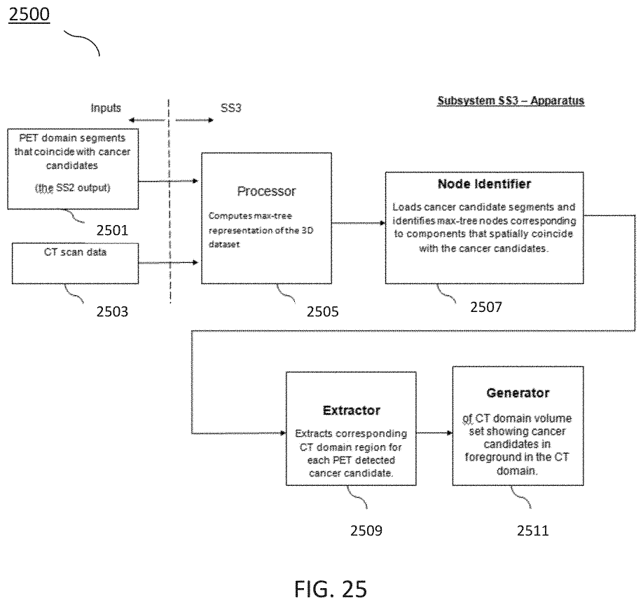

FIG. 25 is a block diagram showing the apparatus of subsystem SS3. Two inputs are received at SS3. One is the PET domain segments at 2501 that coincide with cancer candidates (the SS2 output). The other input is CT scan data 2503. Both are received by Processor 2505 that computes the max-tree representation of the 3D CT dataset, and outputs this to Node Identifier 2507. The Node Identifier loads the cancer candidate segments and identifies max-tree nodes corresponding to components that spatially coincide with the cancer candidates. That information is fed to Extractor 2509 that extracts a corresponding CT domain region for each PET detected cancer candidate. This extracted CT domain information is delivered to Generator 2511 which generates a binary volume set showing cancer candidates in the foreground in the CT domain.

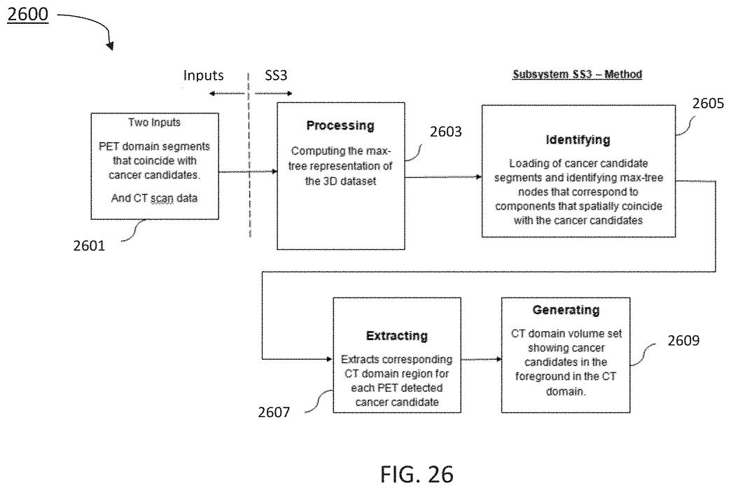

FIG. 26 is a flow chart showing steps in the method of subsystem SS3. Inputs 2601 to SS3 are the PET domain segments that coincide with cancer candidates, and CT scan data. The first step of SS3 is the Processing 2603 of the data by computing the max-tree representation of the 3D dataset. This is followed by identifying at 2605 certain max-tree nodes. This involves loading the cancer candidate segments, then identifying the nodes that correspond to components that spatially coincide with the cancer candidates. This is followed by an Extracting step at 2607 where corresponding CT domain regions are extracted for each PET detected cancer candidate. The final step is for Generating 2609. Here, a binary volume set is generated showing cancer candidates in the foreground in the CT domain.

SS4—Classification of Cancer Vs Other Conditions.

Having segmented all possible cancer candidates from the CT scan, this last subsystem classifies whether each segment corresponds to a cancer or some other condition. This is done using the successive cross sections of each segment along with a neural network binary classifier. If the classifier detects a segment as cancer it is retained and reported; otherwise it is discarded in its entirety. Each retained segment that is a verified cancer can then be quantified (size, shape, location, extent, density, etc.) using binary connected component attribution and reported separately.

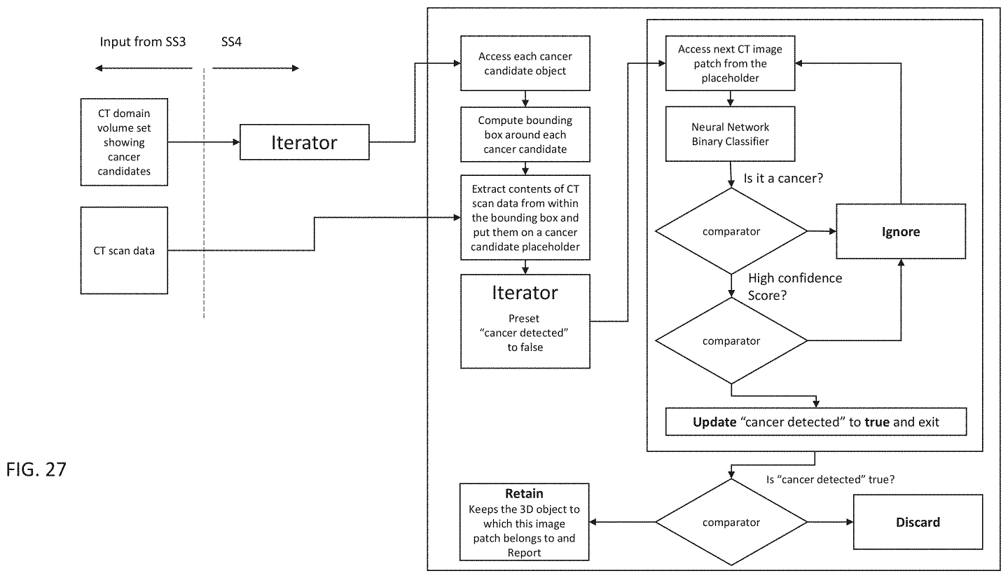

FIG. 27 is a block diagram illustrating the apparatus and method of subsystem SS4. Input 2701 is a CT domain binary volume set showing cancer candidates as segmentations, this being outputted from subsystem SS3, and input 2701a is the CT data set. For each binary cancer candidate that is a 3D segment, the masker at 2701b computes its minimal enclosing bounding (MEB) box and uses that to extract the corresponding image regions of the CT data set that are found within the MEB box. The masker returns a set of consecutive image patches for each 3D cancer candidate. Each set of image patches is labeled with a unique identifier that points to the 3D cancer candidate and is received by Iterator 2702. The iterator processes one image patch at a time using a neural network binary classifier 2703. In this embodiment the neural network binary classifier is pre-trained to identify lung cancer in 2D images of CT scans from other conditions or healthy lungs.

The classifier determines if an image patch contains a lung cancer or not. If classifier determines an image patch to be a cancer image, the candidate segment to which this patch points to is relabeled as a cancer and is sent to Retain and Report module 2709 where an alert is issued and the cancer (or other targeted condition) is reported in a CT domain output image. On the other hand, if comparator 2707 determines a candidate is not cancer, it feeds the candidate to Discard 2711 where it is discarded. This process of sorting is repeated for each 3D cancer candidate segment.

Upon cancer detection and for reporting purposes, each relabeled 3D segment is attributed using binary connected component labeling and attribution methods. The attributes can include the physical size, compactness, intensity, density and location of the cancer in the output image. If other reference anatomical features are provided externally, the proximity of each segment to them is also calculated and reported.

It will be apparent to those skilled in the art that various modifications and variations can be made to the disclosure described above without departing from the spirit or scope of the disclosure. Thus, it is intended that the present disclosure cover modifications and variations that come within the scope of the appended claims and their equivalents.

1. A method for detecting at least one body organ anomaly that is visually distinguishable from other body areas using a CT scan and a PET scan, the one body organ has an anatomical point in space, the method comprises:
stacking CT images generated by a CT scan;
stacking PET images generated by a PET scan;
registering the stacked CT and stacked PET images, wherein data points from each of the stacked images are aligned and correspond spatially to the same anatomical point;
segmenting out a targeted area from the CT image stack; and
overlaying the segmented out target area with the registered PET data to identify the location of the anatomical point in the PET data.

2. A method for detecting lung cancer from at least one CT scan and at least one PET scan comprising:
Automatically segmenting an organ into 3 dimensional data from the CT scan in the absence of 3D training data, and with a collection of annotated organ cross-section images;
Automatically extracting organ anomalies in 3 dimensions from the PET scan using the automatically segmented organ 3 dimensional data as a driver; and
Automatically recovering the organ anomalies from the CT scan using the automatically segmented organ anomaly from the PET scan.

3. A tomographic system for detecting the location of at least one tissue anomaly from a mass of tissues in a patient, the tomographic system comprising:
a series of penetrating wave generators, each generator transmitting a penetrative wave positioned at unique angles directed to the mass of tissues in the patient;
a series of scanners each to
measure an attenuation pattern corresponding with each of the transmitted penetrating waves generated; and
generate at least one image in response to each measured attenuation pattern, each image reduced to a data set;
an aligner to spatially align each of the images corresponding with the unique angle of each of the measured attenuation patterns;
a comparer to compare the spatially aligned images and to identify the location of the at least one anomaly from the measured attenuation patterns.

4. The tomographic system of claim 3, wherein each of the images corresponds with a data set.

5. The tomographic system of claim 4, wherein the transmitted penetrating waves comprise at least one of electromagnetic radiation, laser, magnetic resonance, magnetic induction, microwave, photoacoustic, Gamma-ray, ultrasound and X-ray.

6. The tomographic system of claim 5, wherein tomographic system further comprises at least one of a CT scanning system and a PET scanning system.

7. The tomographic system of claim 6, wherein the location of the at least one tissue anomaly identified by the comparer includes three-dimensional coordinates.

8. The tomographic system of claim 7, further comprising:
a first memory to store each image generated by the CT scanning system; and
a second memory to store each image generated by the PET scanning system.

9. The tomographic system of claim 8, further comprising:
a first data system to stack each data set of the CT scanning system in the first memory; and
a second data system to stack each data set of the PET scanning system in the second memory.

10. The tomographic system of claim 9, further comprising:
a computer processor to
register each of the data sets from the CT scanning system and from the PET scanning system, and
to spatially align both of the data sets.

11. The tomographic system of claim 10, wherein the computer processor further segments out a targeted area from the CT image stack.

12. The tomographic system of claim 11, wherein the computer processor further overlaying the segmented out target area with the registered PET data set to identify the location.
